(19) United States
(12) Patent Application Publication
(10) Pub. No.: US 2006/0147583 A1
(43) Pub. Date: Jul. 6, 2006

(54) Lumpy product in animal food compositions and process for the production thereof

(76) Inventors: Johannes Schlebusch, Bremen (DE); Siegfried Schmidt, Verden/Aller (DE); Siegfried WAigand, Munich (DE); John Hemus, Verden/Aller (DE)

Correspondence Address: FROMMER LAWRENCE & HAUG, 745 FIFTH AVENUE- 10TH FL., NEW YORK, NY, 10151, US

(21) Appl. No.: 11/143,547

(22) Filed: Jun. 1, 2005

Related U.S. Application Data
(63) Continuation of application No. 09/806,234, filed on Mar. 28, 2001, now abandoned.

(30) Foreign Application Priority Data
Sep. 28, 1998 (DE) 19844393.5
Sep. 28, 1999 (WO) PCT/DE99/03125

(51) Int. Cl. A23L 1/31

(52) U.S. Cl. 426/92

(57) ABSTRACT

Lumpy product or chunk, which is suitable for admixing to or as the sole constituent of animal food compositions and which contains proteins, one or more water-binding components, water and salt, in which it co mprises at least one phase, where the proteins as a result of a suitable denaturing stage form a high strength able to withstand processes such as sterilization and storage for several years without significant strength losses.

### BACKGROUND OF THE INVENTION

The present invention relates to a lumpy product in animal food compositions and to a process for the production thereof.

Although nowadays there are numerous different animal foods in varied forms, they can be subdivided into two groups; on the one hand conventional instant animal foods, comprising a solid and a liquid phase, i.e. generally pieces of meat and a sauce or gravy around said pieces; and dry foods, in the form of specially shaped pellets, which result from a strong water abstraction, e.g. complete baking of a semifluid paste.

It has been found that in the case of instant animal food consisting of pieces of meat and gravy, the solid constituents of the food can easily stick to the teeth of the animal and consequently contribute to a much worse oral hygiene. In addition, due to the pasty or very soft consistency of the food the latter, instead of being chewed, is swallowed. No adequate comminution of the food takes place in the mouth, so that digestion is transferred to the gastrointestinal tract. As a result of an increased eating rate and the gulping of the food by the animal, no adequate salivation occurs and consequently the mouth is inadequately cleaned with respect to bacteria.

Dry foods must be mechanically comminuted in chewing-intensive manner, so that as a result of chewing dental plaque is reduced and the gums have a better blood flow. Compared with moist foods, dry foods are not eaten as readily and can even be refused by the animal.

Tests have been carried out for the production of a lumpy animal food without using meat lumps. Thus, DE 2 728 512 A1 and DE 2 650 800 A1 disclose a wet food for pets, which has as a constituent heat-stable, meat-like blood-based lumps and provide a formulation for the lumps which is characterized by the presence of blood constituents and rubber. In both documents the strength of the lumps is determined by the addition of a given rubber quantity. Optionally, as a further ingredient, use can be made of an additional protein source, which can comprise animal or vegetable protein or mixtures thereof. However, the strength is solely determined by the addition of a suitable rubber. A graded setting of the strength and texture of the lump is not possible.

An object of the invention is to combine the positive aspects of the two animal food types, i.e. the health-encouraging aspect of dry food with the comparatively higher consumption attractiveness of the two-component instant food.

A further object of the invention is to provide a chunk in which the texture and strength can be adjusted in a graded manner, together with a process for the production thereof.

### SUMMARY OF THE INVENTION

According to the invention, these objects are achieved by a lumpy product or chunk, which is suitable for admixing in or as the sole constituent of animal food compositions and which contain proteins, one or more water-binding components, water and salt, characterized in that it comprises at least one phase, in which the proteins, as a result of a suitable denaturing stage, form a matrix characterized by high strength and which is able to withstand processes such as sterilization and storage for several years without significant losses and further characterized in that the proteins come from concentrated blood plasma and/or blood plasma powder and/or egg albumin powder and/or wheat gluten and/or soybean proteins. Additionally, the water-binding components are either obtained form the group flour/starch/waxy maize starch or the group silica/physiologically unobjectionable metal oxides/other atoxic inerts, water-absorbing substances or the group cellulose powder/plant fibers or a combination of substances from the different groups. The texture of the chunk is defined solely through the choice of the nature and quantity of the proteins and water-binding components.

It has been found that such a lump product, hereinafter called chunk for short, has a much greater strength than conventional meat pieces in a two-component instant food, so that the animals are forced to intensively chew the food, which leads to a reduction of dental plaque and a chunk according to the invention is gladly consumed by animals. Simultaneously through the planned choice of ingredients, it is possible to vary and adjust the texture of the chunks from brittle to elastic in accordance with individual needs or the planned use of the animal food. The ingestion of the chunks according to the invention takes place as a result of intensive chewing instead of gulping and for animals would appear to be more interesting than the consumption of conventional animal foods.

For solving the set problem importance is attached to the particular choice of functional proteins, alone or combined with other constituents having a cereal base, e.g. wheat flour, in order to obtain the desired texture characteristics. The desired texture results from the fact that- the specifically chosen combination of proteins is coagulated, the released water is absorbed by the wheat flour, which is thereby made into a paste. Optionally a further water-binding component can be added, whose choice with regards to nature and quantity also has a decisive influence on the texture of the chunk. Thus, a chunk is provided, whose texture can be adjusted according to needs.

In order to ensure an increased strength of the protein matrix, it is in particular provided that the fat/oil proportion in the solid phase of the chunks according to the invention represent below 5% and preferably below 2%. The proteins of the chunks emanate from concentrated blood plasma and/or blood plasma powder and/or egg albumin powder and/or wheat gluten and/or soy proteins.

A preferred embodiment is characterized in that the water-binding components come either from the group of flour/starch/waxy corn starch or the group of silicas/physiologically unobjectionable metal oxides/other non-toxic inerts, water-absorbing substances or the group of cellulose powder/vegetable fibers or a combination of substances from the different groups.

For the production of the chunks according to the invention, it is in particular provided that the weight ratio of the protein-containing ingredients to the water-binding components is in the range 2.5:1 to 0.3:1. In a preferred embodiment, the weight ratio is 2:1. In another embodiment, the weight ratio is 0.48:1.

It is in particular provided that following the production of the chunks, the content of proteins represents 10 to 35 wt. %, of flour/starch/waxy corn starch 15 to 40 wt. % and of silicas/physiologically unobjectionable metal oxides/other non-toxic inerts, water-absorbing substances or cellulose powder/vegetable fibers 5 to 25 wt. %.

Following production, preferably the ratio of proteins to flour is between 0.6 and 1.4, the moisture content being between 35 and 65%, the carbohydrate content between 10 and 30% and the fat proportion below 5%, preferably below 2%.

In another preferred embodiment, the chunks comprise an inner and an outer phase, the outer phase containing the high strength protein matrix which is at least 10 and preferably at least 18 times more resistant to deformation than the inner phase. The inner phase is formed from cooked or uncooked meat fractions.

In another preferred embodiment, the chunks comprise an inner and an outer phase, the inner phase containing the high strength protein matrix and is at least 10 and preferably 18 times more resistant to deformation than the outer phase, which is an emulsion or a gel or has a soft, easily deformable consistency.

It is stressed that the limitation of the description to chunks comprising only two phases is not to be understood as a restriction. In fact, the invention also covers chunks with three, four or more phases, which differ as regards their strength.

The invention also relates to a process for the production of a lumpy product or chunk, in which for the production of the high strength phase, the proteins are dissolved in water. The water-binding substances are then dispersed in the protein solution. The viscosity of the thus obtained suspension is adjusted by an appropriate addition of swellable or water-absorbing substances. The obtained phase is shaped into strands of a clearly defined size. The obtained strands undergo a denaturing stage and are then cut to an appropriate size and are packed and sterilized alone or, optionally, with other components. Further, the texture of the chunk is solely determined by the choice of the nature and quantity of the proteins and the water-binding component. The proteins are preferably dissolved in water, accompanied by the addition of salt. According to the invention, it is also preferred that the water-binding substances, which are dispersed in the protein/salt solution, belong to the flour/starch/waxy corn starch group.

For the purpose of adjusting the viscosity of the suspension, use is preferably made of one or more substances from the group flour/silica/physiologically unobjectionable metal oxides/other non-toxic, inert water-absorbing substances/cellulose powder/vegetable fibers.

According to a preferred embodiment of the invention, the shaped strands have an average diameter of 10 to 35 mm.

It is particularly preferable for the process according to the invention, that the denaturing stage involves a temperature change or a pH-value change. In a preferred embodiment of the invention, the temperature is raised to at least 85° C. for carrying out the denaturing stage.

Preferably, following the cutting stage, the chunks obtained have a size suitable for consumption.

The invention is described in greater detail hereinafter relative to the following examples and drawings.

### BRIEF DESCRIPTION OF THE DRAWINGS

FIG. 1 is a cross-section through a nozzle for producing a two-phase chunk and the diagrammatic representation of a two-phase chunk following production.

FIG. 2 is the representation of the force required for breaking open the two phases in a two-phase chunk.

### EXAMPLE 1

Formulations and Analytical Results of the Solid Phase of a Chunk According to the Invention

In order to determine the influence of different ingredients on the biting consistency and texture, experiments were carried out with different formulation compositions according to Table 1. It has been found that in particular the absence of silica or the presence of wheat gluten or cellulose powder led to a produced chunk having an elastic consistency. The brittle chunks produced with silica only differed slightly from the analytical standpoint from the elastic chunks produced without silica, as can be gathered from Table 2. Elastic chunk 3 has the lowest moisture content.

TABLE 1
Formulations for the solid phase of an inventive chunk (values in wt. %)

| | Formulation | | | | |
|---|---|---|---|---|---|
| | 1 | 2 | 3 | 4 | 5 |
| Silica | 10.5 | 13 | — | 11 | — |
| Conc. Blood plasma | 67 | — | — | — | — |
| Albumin powder | — | 18 | 26 | 17.5 | 17.5 |
| Wheat flour | 22 | 25 | 25 | 25 | 25 |
| Wheat gluten | — | — | 8.5 | — | — |
| Cellulose powder | — | — | — | — | — |
| Salt | 0.5 | 0.5 | 0.5 | 0.5 | 0.5 |
| Water | — | 43.5 | 40 | 46 | 46 |
| Total | 100 | 100 | 100 | 100 | 100 |
| Texture | brittle | brittle | elastic | brittle | elastic |

TABLE 2
Analytical results of the chunks produced according to Table 1
(values in wt. %)

| Product | 1 | 2 | 3 | 4 | 5 |
|---|---|---|---|---|---|
| Moisture | 54 | 48 | 45 | 50 | 50 |
| Protein | 15 | 18 | 32 | 18 | 18 |
| Fat | 0.6 | 0.8 | 1.3 | 0.8 | 0.8 |
| Carbohydrates | 14 | 17 | 17 | 17 | 17 |

### EXAMPLE 2

Production of Chunks Having Brittle Characteristics

The missed, dry formulation component of formulation 1 are continuously dosed into a suitable mixer and mixed there with a corresponding amount of water. The viscous paste is shaped by means of nozzles on a steam tunnel to strands and completely baked. The chunks are cut and sterilized in cans.

### EXAMPLE 3

Production of Chunks Characterized by Elastic Characteristics

The mixed, dry formulation components of formulation 3 are continuously dosed in a double-shaft mixer and mixed there with a corresponding amount of water. The viscous phase is shaped by means of nozzles on a steam tunnel to strands and completely baked. The chunks are cut and sterilized in cans.

### EXAMPLE 4

Production of a Two-Phase Chunk ith an Outer, Solid and an Inner, Soft Phase

The ingredients of formulation 3 are mixed in the following way. Firstly, the albumin powder is dissolved, accompanied by the addition of salt in an apparatus and then the wheat flour and wheat gluten are incorporated into the suspension. Phase A obtained is. pumped into the outer tube 1 of a nozzle, which is constructed from two concentrically arranged tubes of different diameters (28 and 16 mm). A conventional phase B, i.e. comprising cooked meat pieces, is pumped through the inner tube 2. The concentric double strand is baked in a steam tunnel and then cut up.

### Example 5

Analytical Results of a Two-Phase Chunk Following Sterilization

The chunks produced according to example 4 were analyzed in phase-specific manner and the results summarized in table 3 were obtained.

TABLE 3
Analytical results in a two-phase chunk after sterilization

| | Solid phase [%] | Soft phase [%] |
|---|---|---|
| Moisture | 65.3 | 67.6 |
| Protein | 14.5 | 9.9 |
| Fat/Oil | 0.3 | 9.5 |
| Ash | 9.3 | 2.6 |

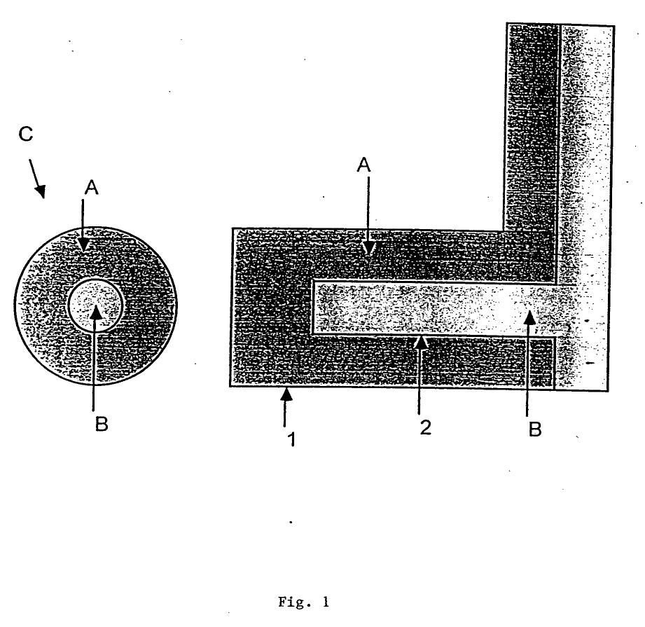

FIG. 1 is a cross-section through a nozzle for the production of-two-phase chunks. An outer tube 1 and an inner tube 2 with different diameters are arranged concentrically and two different phases A and B are pumped through the outer/inner tubes. This leads to an approximately tubular strand, comprising a core phase and a covering phase. The resulting strand is fixed by heat action on a steam tunnel/gas oven and then cut to chunks C of the correct size.

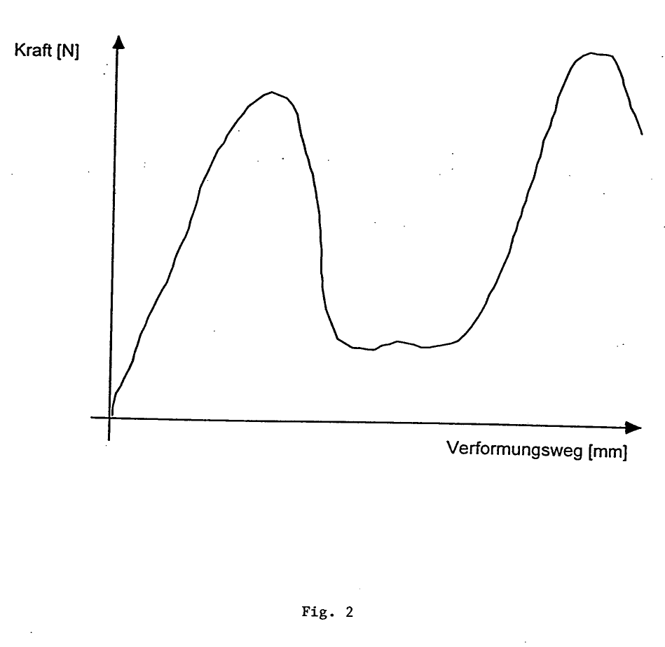

FIG. 2 represents the force required for the breaking open of the two phases in a two- phase chunk. Deformation takes place by means of a mortar or ram and the force is given in Newtons as a function of the deformation path in mm. The two different phase strengths corresponding to the two-stage deformation of the chunks can be seen.

The features of the invention given in the description, claims, tables and drawings can be used to implement the different embodiments of the invention, both singly and in random combination.

What is claimed is:

1. A solid phase chunk, suitable for admixing two, or as the sole constituent of animal food composition, which contains proteins, one or more water-binding components, water and salt, characterized in that it comprises at least one phase, in which the proteins are formed as a result of a suitable denaturing stage of a high strength matrix, which is able to withstand processes such as sterilization and storage for several years without any significant strength losses, and further characterized in that the proteins come from concentrated blood plasma and/or blood plasma powder and/or egg albumin powder and/or wheat gluten and/or soybean proteins, further characterized in that the water-biding components are derived either from a group comprising flower/starch/waxy maize starch or the group comprising silicic acid/physiologically unobjectional metal oxides/non-toxic, inert, water absorbing substances, or from the group comprising cellulose powder/plant fibres, or from a combination of substances from the various groups, further characterized in that solely through the choice of the nature and quantity of the proteins and water-binding components, the texture of the chunk is defined, further characterized in that following the production of said solid phase chunk, the content of protcins is 10 to 35% by weight, the content of flour/starch/waxy maize starch is 15 to 40% by weight, and the content of silicic acid/physiologically unobjectional metal oxides/other non-toxic, inert, water-absorbing substances or cellulose powder/vegetable fibres is 5 to 25% by weight.

2. A chunk according to claim 1, wherein the solid phase of said chunk has a fat or oil proportion below 5%.

3. A chunk according to claim 2, wherein the solid phase of said chunk has a fat or oil proportion below 2%.

4. A chunk according to claim 1 wherein the weight ratio of the protein-containing ingredients to the water-binding components is in the range of 2.5:1 to 0.3:1.

5. A chunk according to claim 1 wherein following its production, the ratio of proteins to flour is between 0.6 and 1.4.

6. A chunk according to claim 1 wherein following he production thereof, the moisture content is about 35 to 65%, the carbohydrate content between 10 and 30% and the fat proportion below 5%.

7. A chunk according to claim 1 wherein following its production, the fat proportion is below 2%.

8. A chunk according to claims, 1, 2, 3, 4, 5, 6 or 7 wherein said chunk comprises an inner and an outer phase said outer phase being between at least 10 and 18 times more deformation-resistant than the inner phase.

9. A chunk according to claims 1,2, 3, 4, 5, 6 or 7 wherein said hunk comprises an inner and an outer phase and wherein said inner phase is a phase comprising cooked or uncooked meat pieces.

10. A chunk according to one of the claims 1, 2, 3, 4, 5, 6 or 7, characterized in that it comprises an inner and an outer phase, the inner phase having a composition according to one of the claims 1, 2, 3, 4, 5, 6 or 7 and is between at least 10 and 18 times more deformation-resistant than the outer phase.

11. A chunk according to claim 1 wherein said chunk comprises an inner and an outer phase and wherein said outer phase is an emulsion or a gel or has a soft, easily deformed consistency.

12. A process for the production of a chunk containing proteins wherein the proteins are dissolved in water, water-binding substances are then dispersed in the protein solution, the viscosity of the resulting suspension is adjusted by an appropriate addition of swellable substances, the resulting phase is shaped to strands having a clearly defined size, the resulting strands are denatured and are then cut to a suitable size and are packed and sterilized alone or optionally with outer components and wherein the texture of the chunk is determined solely by the choice of the nature and quantity of the proteins and the water-binding component.

13. A process according to claim 12 wherein the proteins are dissolved in water, accompanied by the addition of salt.

14. A process according to claim 12 wherein the water-binding substances dispersed in the protein/salt solution are selected from the group consisting of flour, starch, or waxy maize starch group.

15. A process according to claim 12 wherein the viscosity of the suspension is adjusted by the addition of one or more substances selected form the group consisting of flour, silica, physiologically unobjectionable metal oxides, non-toxic inert, cellulose powder, or vegetable fibers.

16. A process according to claim 12 wherein the shaped strands have an average diameter of 1- to 35 mm.

17. A process according to claim 12 wherein the denaturing stage involves a temperature change or a pH-value change.

18. A process according to claim 12 wherein the temperature is raised to at least 85° C. for performing a denaturing state.

19. A processing according to claim 12 wherein the pieces obtained following the cutting stage have a size appropriate for consumption.
